(19) United States
(12) Patent Application Publication
(10) Pub. No.: US 2010/0205918 A1
(43) Pub. Date: Aug. 19, 2010

(54) Filter element, especially for filtering the exhaust gases of an internal combustion engine

(76) Inventors: Hjolger Dietzhausen, Stuttgart (DE); Burkhard Michaelis, Vaihingen/Enz (DE); Peter Hiller, Stuttgart (DE); Tobias Hoeffken, Stuttgart (DE)

Correspondence Address: KENYON & KENYON LLP, ONE BROADWAY, NEW YORK, NY, 10004, US

(21) Appl. No.: 12/308,331

(22) PCT Filed: Jun. 26, 2007
(86) PCT No.: PCT/EP2007/057693

§ 371 Date: Apr. 22, 2010

(51) Int. Cl. B01D 46/24

(52) U.S. Cl. 55/419

(57) ABSTRACT

A filter element, especially for filtering exhaust gases of an internal combustion engine, having inlet channels that are open at the input end and closed at the output end in the flowthrough direction, and having outlet channels that are closed at the input end and open at the output end in the flowthrough direction, the inlet channels and outlet channels being delimited by filter walls, the profile of at least some of the filter walls of an outer region of the filter element being adapted to the profile of an at least locally curved outer side of the filter element.

### FIELD OF THE INVENTION

The present invention relates to a filter element, especially for filtering exhaust gases of an internal combustion engine, and to a particle filter and to an exhaust emissions control system having a filter element.

### BACKGROUND INFORMATION

The exhaust gas to be purified flows through the open-pore filter walls disposed between the entrance channels and exit channels. With time, carbon particles become deposited on the upstream surfaces of the filter walls. These carbon particles result in a decrease in the permeability of the filter walls, and consequently in an increase in the pressure drop that occurs as the gas flow passes through the filter walls. The so-called exhaust gas counterpressure correspondingly rises. When it exceeds a specific value, the filter is regenerated by combusting the deposited carbon particles. For this, the temperature of the exhaust gas directed through the filter element can be increased. This is brought about, for example, by injecting additional fuel.

During regeneration of the filter element, the temperature distribution within the filter element is such that maximum temperatures occur in the interior of the filter element, and much lower temperatures in an outer edge region of the filter element. This leads to locally different thermal expansions, with the result that large mechanical stresses can occur in the filter element. In the least favorable case, these stresses can cause cracks to form in the filter element.

### SUMMARY OF THE INVENTION

It is an object of the present invention to create a filter element with which the aforesaid cracking can be avoided or at least limited.

The object upon which the invention is based is achieved, in the context of a filter element as recited above, in that the profile of at least some of the filter walls of an outer region of the filter element is adapted to the profile of an at least locally curved outer side of the filter element.

### ADVANTAGEOUS EFFECTS

What is achieved with the geometry according to the present invention of the filter walls is that greater stresses can be absorbed in an outer region of the filter element without failure of the material in that region. The tensile forces occurring in an outer region of the filter element can best be absorbed when at least some of the filter walls of the inlet channels and outlet channels disposed in this region are adapted in terms of their profile to the profile of the curved outer side. With a conventional filter element, by contrast, the inlet channels and outlet channels are also offset in checkerboard fashion from one another in an outer region of the element, so that the inlet channels and outlet channels are cut off on the outer side in terms of their substantially square basic shape. These irregularly shaped externally located inlet channels and outlet channels form regions of material weakness that promote cracking.

The filter element according to the present invention can have a substantially cylindrical or oval cross section. In this case the entire outer side of the filter element has a curved profile. It is also possible, however, for the filter element to have an outer side that in cross section is alternately delimited by segments proceeding rectilinearly and segments proceeding in curved fashion. A cross section of this kind has a basic shape that is polygonal, for example triangular or square, in cross section. The edges of these polygons then form segment proceeding rectilinearly, between which (in the corner regions of the basic shape) are provided segments proceeding in curved fashion.

For the aforesaid cross sections, it is advantageous if the filter walls in a region adjacent to the curved outer side are concentric with one another. If some of the filter walls extend in a radial direction, it is thereby possible, with the aid of the filter walls disposed mutually concentrically and with the aid of the filter walls extending in a radial direction, to create inlet channels and outlet channels whose cross section deviates only slightly from a square or rectangular basic shape.

If the filter walls of a row of inlet channels and outlet channels that is directly adjacent to the outer side of the filter element are adapted to the profile of the outer side, the particularly large tensile stresses in this region in the context of regeneration of the filter element can be readily absorbed. It is thereby possible to prevent the formation, in this particularly at-risk region, of cracks that can then propagate into regions less at risk. This can be prevented particularly effectively if the filter walls of several mutually adjacent rows of inlet channels and outlet channels are adapted to the profile of the outer side. It is thereby also possible to avoid abrupt changes in geometry between a row of inlet channels and outlet channels that is located farthest out, and a row of inlet channels and outlet channels that is located internally relative thereto.

The outer region, i.e. the region in which the profile of some of the filter walls is adapted to the profile of the outer side, can extend from the outer side to between 0.1 and 0.4 times the greatest diameter of the filter element.

It is particularly advantageous if the outer region is contiguous to an inner region, polygonal overall in cross section, of the filter element. This polygonal region allows the provision of inlet channels and outlet channels having a conventional geometry, especially when the inner region has an overall cross section that is substantially quadrangular.

The inner region can be embodied in exactly square or rectangular fashion. It is also advantageous, however, if the inner region is bulged outward at its boundaries with the outer region of the filter element, so that a smooth change in geometry is achieved in the region of the transition between the inner region and the outer region. An overall geometry that can also be referred to using the term “O-grid” can be achieved in this fashion. This is characterized in that an overall circular or oval cross section of a cylindrical or oval filter element can be filled up with channels that are quadrangular in cross section, without thereby causing the cross sections of the individual channels to deviate greatly from a square or rectangular shape.

The above-described “O-grid” geometry can be associated with the fact that the outer region is subdivided into segments, the segment boundaries between the segments proceeding in a radial direction. These segment boundaries can extend from the outer side of the filter element as far as corner regions of the inner region of the filter element. The cross section of the filter element is thereby divided into an inner region and segments of the outer region. Based on the geometrical conditions generated thereby, a particularly uniform distribution of inlet channels and outlet channels that are respectively quadrangular in cross section can be achieved.

In order to be able to achieve the highest possible mechanical strength values in the region of the transition between the inner region and individual segments of the outer region, it is proposed that in a corner region of the inner region of the filter element, a filter wall forming a segment boundary, and two further filter walls, encounter one another in such a way that an angle of 100° to 140°, in particular of 110° to 130°, more particularly of 120°, is enclosed between each two filter walls. The aforesaid two further filter walls simultaneously constitute the boundaries between the internally located region and the outer segments respectively adjacent thereto.

With a conventional checkerboard disposition of inlet channels and outlet channels, each inlet channel is adjacent to four outlet channels, and each outlet channel to four inlet channels. To allow a geometric relationship of this kind also to be achieved in the corner regions of the inner region of the filter element, it is proposed that two channels contiguous to a segment and adjacent to one another in a circumferential direction be combined into one common inlet channel, and that two channels adjacent thereto transversely to the circumferential direction be combined into one common outlet channel.

Further advantages and advantageous embodiments of the invention are evident from the drawings below, the description thereof, and the claims. All features described in the drawings, the description thereof, and the claims may be essential to the invention both individually and in any combination with one another.

### BRIEF DESCRIPTION OF THE DRAWINGS

FIG. 1 schematically depicts an internal combustion engine having an exhaust emissions control system and having a filter element.

FIG. 2 is a longitudinal section through the filter element.

FIG. 3 is a schematic cross section of the filter element.

FIG. 4 is a detailed cross section of the filter element according to a first embodiment.

FIG. 5 is a detailed cross section of the filter element according to a second embodiment.

### DETAILED DESCRIPTION

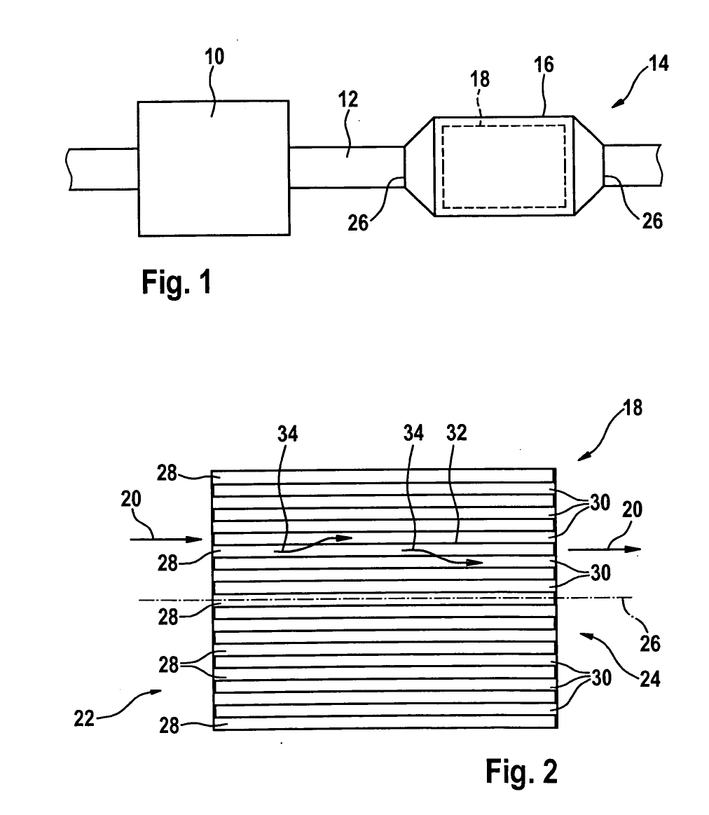

In FIG. 1, an internal combustion engine bears the reference character 10. Exhaust gases are directed through an exhaust pipe 12 to an emissions control system 14. The latter encompasses a particle filter 16 with which carbon particles are filtered out of the exhaust gas flowing in exhaust pipe 12. This is necessary especially in diesel internal combustion engines in order to comply with regulatory stipulations.

Particle filter 16 encompasses a filter element 18 that is substantially cylindrical in its entirety.

FIG. 2 depicts filter element 18 in a longitudinal section. Filter element 18 can be manufactured, for example as an extruded shaped member, from a ceramic material such as, for example, cordierite.

Exhaust gas of internal combustion engine 10 flows through filter element 18 in the direction of arrows 20. In FIG. 2 an entrance surface for the exhaust gas to be filtered carries the reference character 22, and an exit surface for filtered exhaust gas carries the reference character 24.

Several inlet channels 28 and outlet channels 30 proceed parallel to a longitudinal axis 26 of filter element 18. Inlet channels 28 are open at entrance surface 22 and closed at exit surface 24. Conversely, outlet channels 30 are open at entrance surface 24 and closed in the region of entrance surface 22.

The flow path of unpurified exhaust gas thus leads into one of inlet channels 28 and from there through a filter wall 32 into one of outlet channels 30. This is depicted, by way of example, by arrows 34.

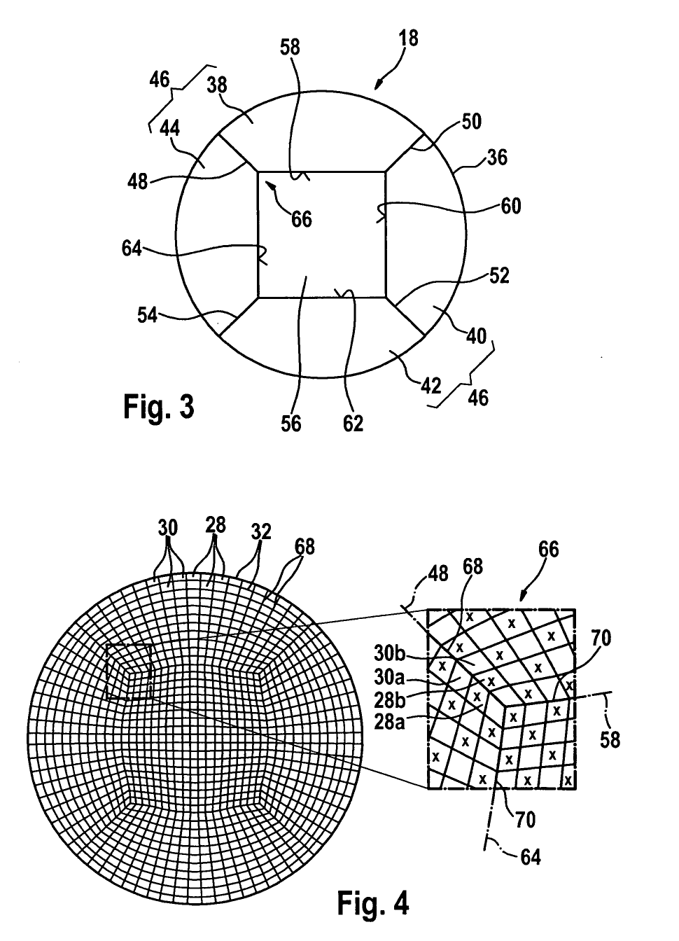

FIG. 3 schematically depicts filter element 18 in cross section. Disposed within a cylindrical outer side 36 are four radially outer segments 38, 40, 42, and 44 that together form a radially outer region 46 of filter element 18. They abut against one another at segment boundaries 48, 50, 52, and 54 that proceed in a radial direction.

Filter element 18 furthermore has an inner region 56 that is square in cross section. It extends within boundaries 58 to 64. Constituted between the aforesaid boundaries are corner regions 66 at which segment boundaries 58 to 54 also terminate.

Whereas FIG. 3 depicts the cross section of filter element 18 in a simplified, schematic form, FIG. 4 shows an optimized distribution of inlet channels 28 and outlet channels 30 that builds on this basic shape. It is apparent in FIG. 4 that inlet channels 28 and outlet channels 30 disposed in radially outer region 46 of filter element 18 are each delimited by filter walls 32 substantially concentric with one another, and by filter walls 68 proceeding substantially in a radial direction. It is further evident from FIG. 4 that several mutually concentric rows of channels 28 and 30 are disposed in radially outer region 46. In the selected exemplifying embodiment, radially outer region 46 extends in a radial direction over somewhat more than half the radius of filter element 18.

Corner region 66, also indicated in FIG. 3, is depicted in detail to the right in FIG. 4. It is apparent therefrom that boundaries 58 and 64 of inner region 56, and segment boundary 48 between segments 38 and 44, butt against one another. Boundaries 58 and 64, and segment boundary 48, are formed respectively by filter walls 68 and 70.

In FIG. 4, inlet channels 28 are each identified by an X symbol. Outlet channels 30 are disposed with a respective offset from them. It is apparent from FIG. 4 that each inlet channel 28 is adjacent to four respective outlet channels 30, and each outlet channel 30 to four respective inlet channels 28. This is not true, however, for the region adjacent to segment boundary 48 or to filter wall 68. Here two inlet channels 28a and 28b, and two outlet channels 30a and 30b, are respectively adjacent to one another.

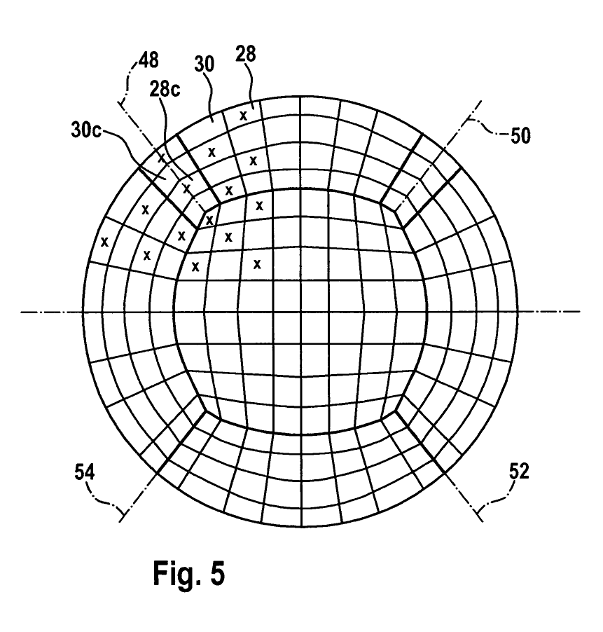

To allow a uniform distribution of inlet channels 28 and 30 also to be achieved in the region of segment boundaries 48 to 54, a geometry as described below is proposed. The portion depicted in FIG. 5 below a dot-dash horizontal line (without reference character) corresponds to the geometry as shown in FIG. 4. The portion above the horizontal line in FIG. 5 has a geometry that is modified as compared with FIG. 4. In the region of segment boundary 48, inlet channels 28a and 28b are combined into one common inlet channel 28c. Correspondingly, outlet channels 30a and 30b are combined into one common outlet channel 30c. It is thereby possible to generate, over the entire cross section of filter element 18, a structure in which each inlet channel 28 is disposed adjacent to four respective outlet channels 30, and each outlet channel 30 adjacent to four respective inlet channels 28.

1-18. (canceled)

19. A filter element, for filtering exhaust gases of an internal combustion engine, comprising:
inlet channels that are open at an input end and closed at an output end in a flowthrough direction;
outlet channels that are closed at the input end and open at the output end in the flowthrough direction, the inlet channels and the outlet channels being delimited by filter walls;
wherein a profile of at least some of the filter walls of an outer region of the filter element is adapted to a profile of an at least locally curved outer side of the filter element, the outer region being contiguous to an inner region, polygonal overall in cross section, of the filter element, and the inner region being bulged outward at its boundaries with the outer region of the filter element.

20. The filter element of claim 19, wherein the filter element has a substantially cylindrical cross section or oval cross section.

21. The filter element of claim 19, wherein the filter element has an outer side that in cross section is alternately delimited by segments proceeding rectilinearly and segments proceeding in curved fashion.

22. The filter element of claim 19, wherein the filter walls in a region adjacent to the curved outer side are disposed concentrically with one another.

23. The filter element of claim 19, wherein some of the filter walls extend in a radial direction.

24. The filter element of claim 19, wherein the filter walls of a row of inlet channels and outlet channels that is directly adjacent to the outer side of the filter element are adapted to the profile of the outer side.

25. The filter element of claim 19, wherein the filter walls of several mutually adjacent rows of the inlet channels and the outlet channels are adapted to the profile of the outer side.

26. The filter element of claim 19, wherein the outer region of the filter element extends from the outer side to between 0.1 and 0.4 times the greatest diameter of the filter element.

27. The filter element of claim 19, wherein the inner region has a cross section that is substantially quadrangular overall.

28. The filter element of claim 19, wherein the filter walls provided in the inner region are disposed so that the inlet channels and outlet channels delimited by said filter walls have an at least approximately square cross section.

29. The filter element of claim 19, wherein the outer region is subdivided into segments, and wherein segment boundaries between the segments proceed in a radial direction.

30. The filter element of claim 29, wherein the segment boundaries extend from the outer side of the filter element as far as corner regions of the inner region of the filter element.

31. The filter element of claim 30, wherein in a corner region, a filter wall forming a segment boundary, and two further filter walls, encounter one another so that one of (i) at an angle of 100° to 140°, (ii) at an angle of 110° to 130°, and (iii) at an angle of 120°, is enclosed between each of the two filter walls.

32. The filter element of claim 29, wherein two channels contiguous to a segment boundary and adjacent to one another in a circumferential direction are combined into one common inlet channel, and two channels adjacent thereto transversely to the circumferential direction are combined into one common outlet channel.

33. A particle filter, comprising:
a filter element for filtering exhaust gases of an internal combustion engine, including:
inlet channels that are open at an input end and closed at an output end in a flowthrough direction;
outlet channels that are closed at the input end and open at the output end in the flowthrough direction, the inlet channels and the outlet channels being delimited by filter walls;
wherein a profile of at least some of the filter walls of an outer region of the filter element is adapted to a profile of an at least locally curved outer side of the filter element, the outer region being contiguous to an inner region, polygonal overall in cross section, of the filter element, and the inner region being bulged outward at its boundaries with the outer region of the filter element.

34. An exhaust emissions control system, comprising:
a particle filter, including:
a filter element for filtering exhaust gases of an internal combustion engine, including:
inlet channels that are open at an input end and closed at an output end in a flowthrough direction;
outlet channels that are closed at the input end and open at the output end in the flowthrough direction, the inlet channels and the outlet channels being delimited by filter walls;
wherein a profile of at least some of the filter walls of an outer region of the filter element is adapted to a profile of an at least locally curved outer side of the filter element, the outer region being contiguous to an inner region, polygonal overall in cross section, of the filter element, and the inner region being bulged outward at its boundaries with the outer region of the filter element.
